(19) United States
(12) Patent Application Publication
(10) Pub. No.: US 2010/0101110 A1
(43) Pub. Date: Apr. 29, 2010

(54) WELL-BEING BODY DRIER AND ITS CONTROLLING METHOD

(75) Inventor: Deok Gu Lee, Busan (KR)

Correspondence Address: IPLA P.A., 3550 WILSHIRE BLVD., 17TH FLOOR, LOS ANGELES, CA, 90010, US

(73) Assignees: Kwon Hwan Lee, Busan (KR); Deok Gu Lee, Busan (KR)

(21) Appl. No.: 12/531,085

(22) PCT Filed: May 1, 2008
(86) PCT No.: PCT/KR08/02479

§ 371 Date: Sep. 14, 2009

(30) Foreign Application Priority Data
May 10, 2007 (KR) 10-2007-0046291
Nov. 13, 2007 (KR) 10-2007-0115270

(51) Int. Cl. F26B 3/00; F26B 21/00

(52) U.S. Cl. 34/488; 34/565

(57) ABSTRACT

The present invention relates to a well-being body drier and a method for controlling it. More specifically, the present invention relates to a body drier designed to remove moisture in a bathroom to thereby inhibit various bacterium and smell, to blow uniform hot air to thereby prevent skin from excessively drying and prevent skin diseases, to reduce a mechanical noise due to an action of air guide without change of blast pressure, and to warm bathroom air upon senior's bathing to thereby prevent taking cold, and to a method for controlling the body drier which blows a hot air while repeated revolving within a range of a certain angle a discharge opening to a head part, a body part and a leg part of users. According to the present invention, there is provided a well-being body drier, including a case wherein an air blower motor and an air blower revolved by the air blower motor are mounted, an opening part being formed in the upper part and the front direction, and a plurality of intake openings being formed in the lower part; an air guide which is mounted to surround the air blower, a discharge opening being mounted to project in the front direction, and to revolve in an opening part of the case within a range of a certain angle; and a heating element mounted in the above discharge opening.

### TECHNICAL FIELD

The present invention relates to a well-being body drier and a method for controlling it. More specifically, the present invention relates to a body drier designed to remove moisture in a bathroom to thereby inhibit various bacterium and smell, to blow uniform hot air to thereby prevent skin from excessively drying and prevent skin diseases, to reduce a mechanical noise due to an action of air guide without change of blast pressure, and to warm bathroom air upon senior's bathing to thereby prevent taking cold, and to a method for controlling the body drier which blows a hot air while repeated revolving within a range of a certain angle a discharge opening to a head part, a body part and a leg part of users.

### BACKGROUND ART

Body drier is an apparatus mounted in a wall section of bathroom to dry a wet body after bath with hot air or to prevent from taking cold by increasing a bathroom temperature before and after bath. Such conventional body drier includes a case wherein an intake opening inflowing a room air is formed and a discharge opening discharging a hot air is formed; an air blower motor mounted within the case; an air blower revolved by the blower motor; and two-way wing mounted to revolve to a discharge opening so that a hot air occurred by the blower is blown in various directions.

Therefore, it dries a wet body due to an operation of a body drier or it warms a room air before and after bath to prevent taking a cold.

### DISCLOSURE OF INVENTION

### Technical Problem

The above mentioned conventional structure fails to discharge a hot air by a regular air pressure and also it has a noise. That is, a conventional blast was produced by an air blower, and the direction of the blast was controlled by a plurality of directional wings mounted in the discharge opening. An angle change of a directional wing was produced by an air blower to act as resistance to an air pressure blown by a discharge opening, and thereby a blast pressure was changed and the noise was much produced.

Accordingly, the present invention aims at uniformly improving a noise due to a directional wing and an irregular air pressure as mentioned above. The conventional one has a problem in that the discharge opening can be exposed in the exterior to inflow foreign materials such as dust in the interior and thus, it is unsuitable in a sanitary and appearance aspect.

That is, the present invention provides a body drier (driving system) suitable for current Korean bathroom culture, and places an emphasis in significantly reducing a mechanical noise which is one of disadvantages the hair dryer or several driers have until now. Such problem has been resolved by applying bathroom air producing various bacteria and odor due to moisture to a hot air, a deodorizing far infrared and a drier having anion radiation function. When drying a body after taking a shower, it may not suitable for a skin health due to an excessive dry of skin and a strong air spray.

In this light, the present invention places an emphasis in a medical instrument well-being function and a bathroom human engineering ubiquitous product which assists in preventing atopic diseases by radiating loess far infrared anion during dry and is helpful even in health such as women skin aging resistance.

Also, the present invention is designed to place an emphasis in a rapidly changing bathroom interior and to consider the interchangeable even in interior by entering a discharge opening into the machine upon non-operation so as to be exchanged even in any place.

The present invention may escape from a concern of common cold in case of bathing after heating bathroom air for 5 minutes when used upon bathing of children and seniors in a general home building not supplying a heat in a bathroom.

Like this, the present invention is designed to easily use without distinction of age or sex and is a product useful for silver town or hospital.

The invention aims at contribution of healthy bathroom culture in Korea as well as in the whole world.

### Technical Solution

In order to accomplish the above object, the present invention provides a structure which includes an air guide surrounding an air blower, forms a discharge opening in an air guide, and which designs so that a blast resistance of hot air blown is not produced by revolving the air guide at a certain angle, and thereby a regular blast pressure is maintained and a noise is reduced.

Also, when not using it, a structure inserted in a case by a situation where a discharge opening is down-warded by revolving an air guide, is provided. By doing so, a structure of preventing intake of foreign material such as dust and making an appearance beautiful is provided.

That is, the present invention may call the next generation drier which mounts a high speed low noise motor and a low noise blower attaching to an air guide and provides well-being function.

This drier is a blowing system mounted with a heat exchange and is used as a product such as electric fan, air conditioner, hair dryer or had drier.

Every product forms a sales market.

The heat exchanger and the air blower, important elements, are developed to optimize in compliance with each object.

A hand drier can be counted as the most similar product to a new concept body drier, and the functional aspect of the product and constitutional module are similar, but there is a big difference in moving a hand, a dry subject, in a fixed blowing system. A new concept body drier of the present invention attaches to a bathroom wall or furniture and produces a hot air while a blast module provided in the heat exchanger conducts a revolution motion upwardly and downwardly in a body, a dry subject.

In order to supply an air of uniform temperature to the body due to a geometric distance difference from head and leg in a fixed blast system, a heat exchange volume and an air volume must be organically controlled according to a revolution angle of blast module.

A general body drier has been manufactured to be unsuitable for Korean building or bathroom interior and has shown a considerable difference as compared with a sales volume of functional products used in a bathroom like bidet that its demand increases every year, and a state of having no profit even in a general sales volume can refer to a technology of the present drier.

Accordingly, the present invention provides a structure of blast apparatus of the upper and lower revolving body drier which is a structure of heat exchanger of body drier for producing a hot air by human body engineering planning, and an upper and lower driving system structure of an air blowing apparatus including Ubiquitous heat exchanger, a control system of a air blower and a heat exchanger for regular flow rate and hot air. It provides far infrared anion and perfume (pitonchid, aroma) system control and medial instrument function.

### ADVANTAGEOUS EFFECTS

According to the present invention, all air guides surrounding the air blower are revolved to control a discharge direction of hot air. Therefore, since a discharge pressure is not changed, there is no noise due to a blast resistance or pressure change, and a hot air can always blow in a regular blast volume. Then, the direction of a discharge opening is down-warded and it is maintained in a clean sanitary situation without inflow of dust by a structure inserted in the case, and the bathroom wall surface is clean.

Also, skin conducts a most basic function for life maintenance by protecting a human body from foreign bacteria and strains by a protection membrane of all tissue of the body, and takes a functional role, e.g., maintains a body temperature through a sweat discharge and collects foreign information through an antennary cell, one of the senses. As recent environmental problem encounters with a serious situation, the skin is much exposed in wastes and bacteria due to a metropolitan pollution, and the discharge volume of sweat increases due to a greenhouse effect of the earth. For this reason, the time of taking a shower is increased. When skin is not sufficiently dried after taking a shower, the wastes can remain and a secondary pollution can be occurred due to moisture. The Ubiquitous present invention can maintain a clean and healthy skin by completely drying a skin after taking a shower. Thereby, the skin aging is resisted and various skin diseases can be prevented.

Further, the body drier having a heat blower capable of producing a hot air is fixedly attached to bathroom wall and furniture to revolve a blast module upwardly and downwardly. Therefore, the body drier can make use of the minimum space. Because the discharge opening at a fixed position has a different distance of dry part from head to leg of the upper and lower wet body, it is difficult to dry the body in a thermal and hydrodynamic uniform dry condition. Therefore, the present invention can provide a technology capable of properly controlling a blast volume and a blast temperature upon upwardly and downwardly revolving a hot air occurring system.

The present invention relates to a wall-hanging type of well-being body drier having an upward and downward driving manner which radiates a far infrared anion. This body drier can install at a place having bathroom like as a lodging facilities for home or hotel including apartment, a fomenting room and a sauna to be utilized as a foundation facilities for a healthy skin and also can contribute a convenient and plenty life of patients whose behavior is inconvenient of medical instrument like as a hospital, silver town and a disabled welfare facilities.

As a blast system utilized in a daily life, products such as an electric fan, air conditioner, hair dryer and hand drier are used. Every product forms a sales market and a technical development is consistently made. Particularly, an air conditioner industry which is a blast system installed with a heat exchanger, forms a considerable market in Korean and oversea and grows as a national industry. This is a product for increasing a quality of life by combining with an architecture industry and it complies with a basic development concept of the body drier which is the object of the present invention. The hand drier having the most similar type to the body drier is extendedly applied to a wash instrument of public facilities and lodging facilities. The advanced trend of recently newly built apartment and lodging facilities uses the interior of environmentally friendly advanced materials and also is converted into a trend adding a functional aspect of life space. Therefore, adopting a wall-hanging type of well-being body drier having a upward and downward driving manner which radiate a yellow earth far infrared anion according to the present invention leads to a functional Ubiquitous effect and human engineering evolution of the bathroom. In this regard, its use for general home and lodging business is activated and easy. Since the wall-hanging type of well-being body drier having an upward and downward driving manner which radiates a far infrared anion can be used as a medical instrument, it is installed in silver town or the disabled welfare facilities. Therefore, patients, senior and the disabled can overcome their inconvenience in the bathroom to improve the quality of life.

### BRIEF DESCRIPTION OF THE DRAWINGS

FIG. 1 shows a state of use of the present invention.

FIG. 2 is a perspective view showing the internal structure of the present invention.

FIG. 3 is a cross sectional view showing the internal structure of the present invention.

FIGS. 4 and 5 show a state of operation of the air guide.

FIGS. 6 and 7 show a state received by the air guide.

FIG. 8 is a detailed view of the heating element.

### DESCRIPTION OF THE NUMERICAL NUMBERS CONCERNING THE MAIN PARTS OF THE DRAWINGS

1: blower motor
2: blower
3: opening part
4: intake opening
5: case
6: discharge opening
7: air guide
8: servo-motor
9: mounting plate
10: cover
11: fixed plate
12: jaw
13: control part
14: heating element
15: far infrared plate
16: heating coil

### BEST MODE FOR CARRYING OUT THE INVENTION

The present invention provides a well-being body drier, comprising a case (5) which has an air blower motor (1) and an air blower (2) revolved by the blower motor (1), wherein an opening part (3) is formed in the upper part and the front part, and a plurality of intake openings (4) are formed in the lower part; an air guide which is mounted to surround the blower (2), a discharge opening (6) is formed to project at a front direction, and provided to revolve in an opening part (3) of the case (5) to a certain angle; and a heating element (14) mounted in the discharge opening (6).

The above air guide (7) is driven by a servo-motor (8) installed within the case (5), but it is revolved on a center of the revolving axis of the blower (2). That is, the mounting plate (9) is projected and mounted within the case (5), and a servo-motor (8) is mounted in the above mounting plate (9). The gear mounted in a revolving axis of the servo-motor (8) is communicated and revolved with the revolving axis fixed to the air guide (7). The above servo-motor (8) has a function to control the revolving speed and the revolving direction. Of course, deceleration due to the gear communication is possible, but the construction having a separate decelerator is possible.

The opening part (3) formed in the upper part of the case (5) is mounted with a cover (10) as the structure which the rear end of the cover (10) is supported and revolved in the case (5). The cover (10) has a structure which places on the upper section of a revolving air guide (7) to cover the upper opening part (3). That is, since the present invention has a structure which the whole air guide (7) is revolved, the discharge opening (6) can be projected in the upper part of the case (5) by revolution. In this case, since the cover (100 has a revolving structure, it can cover the upper part without disturbing revolution of the air guide (7).

A fixed end (11) having a certain depth inside the case (5) is formed in the lower end of the front opening part (3) of the case (5), and an end jaw (12) is formed in the end part of the fixed end (11), so that the discharge opening (6) of the air guide (7) is safely fixed. Therefore, when the drier of the present invention is not operated, the air guide (7) receives to the case 5. Here, the front section of the case (5) can design to make one plane by an air guide (7).

The heating element (14) includes a far infrared plate (15) mounted in the discharge opening (6), and a heating coil (16) spirally rolled to the far infrared plate (15). The far infrared plate (15) can use any material or construction which can radiate a far infrared or anion, e.g., a mica plate or a structure where ceramic is coated with the mica plate or tourmaline, or those wherein only yellow earth is cured to make a yellow earth ceramic plate. Also, it can be used by mounting a plurality of ceramic balls radiating a far infrared and anion to the discharge opening (6). Therefore, as an air properly heated via the heating element (14) passes through a tourmaline and mica plate which radiate the far infrared and anion useful for the human body, any burden does not give to the skin of human being and the body can be naturally dried.

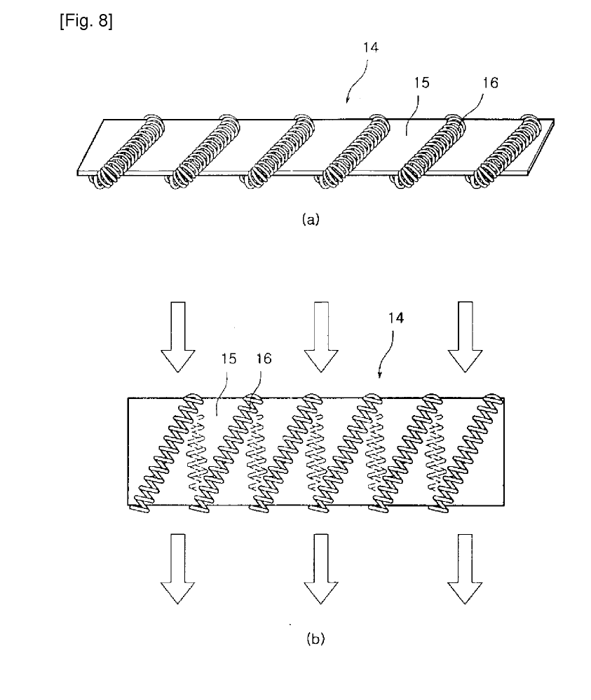

The above heating coil (16) is nickel-chrome hot-wire, nickel strip hot-wire and the like. As shown in FIG. 8, the coil (16) has an interval with an adjacent heating coil (16) by a structure spirally rolled by a certain pitch, and mounted obliquely. By doing so, when a blowing is made, the contact area is broader than a straight line and thus, the heat exchange is easily made.

A wall-hanging type of well-being body drier having an upward and downward driving manner which radiates the above yellow earth far infrared anion is a hot air drying apparatus which sprays a hot air (warm air) while revolving a discharge opening (6) upwardly and downwardly to dry the body after taking a shower. The body drier comprises a blowing revolving apparatus designed to comprise a heating element (14) to heat a blast flow at a certain temperature, a servo-motor (8) for revolving the direction of hot air upwardly and downwardly, and an air guide (7); and a control part (13) for controlling the discharging temperature and blast volume according a revolving angle.

The above figure shows certain flow according to a blowing angle of the discharge opening (6), the end part of the air guide (7), and a flow state controlled by a regular flow rate. In order to dry a wet body, the hot air capable of feeling comfortable is known as 50±5° C. In the discharge opening (6) of the wall-hanging type of well-being body drier having an upward and downward driving manner which radiates the above yellow earth far infrared anion, a heating element (14), a heat exchanger using a electric wire, is mounted to heat the discharge temperature by a hot air. The heat transfer is made by the flow rate determined according to a revolving angle of the discharge opening (6) of the blower. However, the temperature blown according to every position of the body is not regular. Therefore, the electric volume of the electric wire must be controlled according to the upward and downward revolving angle of the discharge opening (6) of the blower.

In the fixed type body drier having a revolving discharge opening, a structure of a cylindrical blower (2) and a heating element (14) for a hot air, and a method for control to maintain a regular flow rate and temperature every body, must be organically combined.

The blower (2) is an apparatus of changing an electric energy into a hydrodynamic energy. It is classified into a centrifugal and axial blower. The centrifugal blower is obtained by a centrifugal force that the energy of air receives from revolution, and the axial blower is those which energy obtains by a lifting force. In the blowing system of the wall-hanging type of well-being body drier having an upward and downward driving manner which radiates the above yellow earth far infrared anion, the structure is simple, and the centrifugal blower is used considering the lowering of the pressure due to a heating element (14) mounted inside the discharge opening (6).

The above figure shows an efficiency curve of the blower, and a centrifugal curve of case (5) and air guide (7). The performance of the air blower is determined by a structure of each part of the blower. Various performances are exhibited according to a pattern of internal wing, a slope direction of the wing, a structure of the intake opening, and a centrifugal curve pattern of case (5) and air guide (7). The body drier containing the air blower (2) is attached to the wall section of bathroom and the head height of furniture. Considering the kinetic energy up to the leg which is a most far distance from the discharge opening occurred by the jet flow, the outlet speed must be sufficiently large.

As shown in the curve from the air blower efficiency according to the discharge air volume, the use range of the blast volume for exhibiting certain efficiency is determined. When a flow control is made to provide a regular flow rate at leg and head while revolving the air blower upwardly and downwardly, the air blower (2) must have a structure for maintaining a sufficient efficiency within a change range of the blast flow rate. The structure of case (5) and air guide (7) mainly uses Archimedes' line considering whole elements such as the maximum air volume, air pressure and efficiency. But, since the pattern of case (5) or air guide (7) has a direct relation to the pattern of external case of the body drier, it can be replaced in the form of Archimedes' line considering other elements.

On the basis of the blast flow rate till the leg, the maximum distance, it must run parallel with a structure of a heating element (14) for ascending an outlet temperature to a certain temperature. In order to maintain the blast flow rate from the body drier to the maximum distance and, at the same time, maintain a hot air to 35±5° C., it has a structure of efficient heating element (14) inside the body drier.

The high temperature part of the heating element (14) mounted inside the discharge opening (6) uses a heating coil (16), a calculation of the electric heat volume must precede considering a flow rate, an outlet temperature and the like. The heating element (14) of the body drier belongs to the heat transfer by a typical forced convection current.

The electric heat volume required for the heating element (14) can be determined by using as an important variant a discharge volume due to the blower (2), the inlet temperature of the heat exchanger, the pressure difference and the like. Upon operation of the body drier, an outlet temperature (To) can be determined in a discharge opening (6) on the basis of the hot air temperature of a leg part, the maximum blast distance. By the mass flow rate coming out through a cross sectional area of the discharge opening (6), a heat quantity of the heating element (14) can be derived from the following equation to exhibit the heat quantity equivalent to the temperature difference of the inlet and outlet.

$$\begin{matrix}{Q}_{i n} = \dot{m} {C}_{p} Δ T = \dot{m} {C}_{p} ( {T}_{o} - {T}_{i} ) & ( 1 ) \\ \dot{m} = ρ V A & ( 2 )\end{matrix}$$

Qᵢₙ: Total heat quantity from an electric heater

Cₚ: Specific heat of air

\dot{m}: Mass flow rate

Tᵢ: Inlet temperature

T₀: Outlet temperature

Since the case (5), a sheath of the body drier, can be manufactured by plastic series (PP), it is necessary to consider a heat cut-off film to prevent a change or discolor due to a radiant heat transfer. Also, since the case is mounted in a bathroom or shower booth, it must be planned so that safety problem due to moisture cannot be occurred and the electrical inhibition problem cannot be occurred.

The above figure shows a heating element (14). When user stands before a body drier to dry the body, the head and leg lead to a geometric distance difference from the discharge opening (6) of the air blower. The jet flow discharged from a discharge opening (6) is revolved and produced in the upward and downward of the body by the blowing revolving apparatus. But, to maintain the blast volume from the discharge opening (6) to the leg which is in a most far distance, the optimum planning of the centrifugal blower must be made, and a control system of properly reducing a blast volume is necessary in a head, a closest distance.

The basic planning type of a body drier aims at drying the body completely wet after taking a shower. But, the construction of the control part (13) must be made to set several modes according to its use condition.

The present invention sets various modes to change a blast volume and a revolving angle of the air guide (7). Thereby, it can operate automatically. That is, various modes can be set and used, e.g., the upper revolving angle and lower revolving angle of the air guide (7) can be set to be blown per body parts of user.

Most basically, there is provided a method for controlling the body drier which dries a moisture of body by controlling the direction of the discharge opening (6) of the air guide (7) mounted in the body drier, which comprises a step of determining an angle of head part determined by a line formed of a discharge opening (6) and an end part of user's head positioned separately at certain distance, and a line formed of a discharge opening (6) and user's neck; an angle of body part determined by a line formed of a discharge opening (6) and neck, and a line formed of a discharge opening (6) and user's waist; an angle of tiptoe determined by a line formed of a discharge opening (6) and a waist, and a line formed of a discharge opening (6) and user's tiptoe; and an angle of body part determined by a line formed of a head end part and a discharge opening (6), and a line formed of a discharge opening (6) and tiptoe; and a step of determining the direction of the discharge opening (6) within a range of angle corresponding to the part for drying user's moisture and carrying out a return-operation within the range of the above determined angle.

Therefore, when drying only head part, when drying only body part, and when drying only tiptoe part, it is sufficient to revolve only at respective corresponding angle. When drying at several sections, the method of revolving respective sections and several sections concurrently can be carried out.

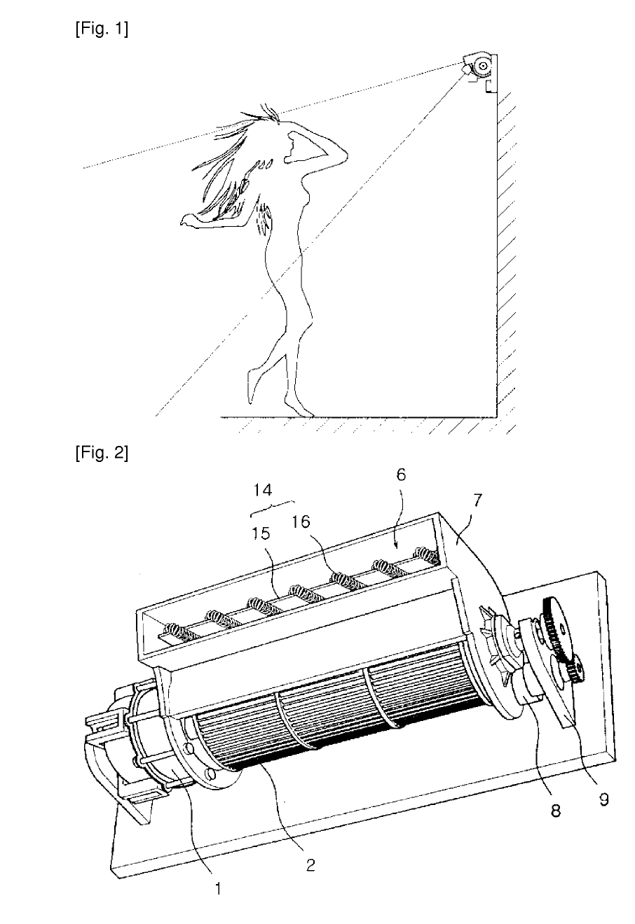

That is, as shown in FIG. 1, a revolving angle of the air guide (7) is changed and operated. It may have the following various operation modes. Of course, the operation mode illustrated below describes merely some of various examples of automatic modules. Various operation methods are possible at various modules such as a manual module and an automatic module.

Assume that the body drier exemplified below is mounted at 2 m height of the wall section, user is separated about 1 m from the wall section, and the height of user is about 175 cm. Therefore, when an air guide (7) of the body drier directs to a head part, it has an angle of about 75 degree with respect to a perpendicular section, and a body part is from a head to hips. When an air guide (7) directs to the hips part, it has an angle of about 43 degree with respect to a perpendicular section, and the leg part is from hips to tiptoe. Here, when an air guide (7) directs to tiptoe, it has an angle of about 25 degree with respect to a perpendicular section.

The first exemplary automatic module 1 is a mode for woman. This is a mode complying with the appetite of woman having long hair style and of peoples who dislike a cold wind. In this case, hair and body are dried by a strong wind. Then, the body and head parts are wholly dried by a swing motion which is an up and down revolution of the air guide (7).

The first step is a step of discharging a head part by hot air and three step wind force for 1 minute and 30 seconds. Then, the air guide (7) is moved to about 32 degree upwardly.

The second step is a step of discharging a body part by hot air and three step wind force for 1 minute. Then, the air guide (7) is moved to about 32 degree upwardly.

The third step is a step of discharging a head part by hot air and two step wind force for 20 seconds. Then, the air guide (7) is moved to about 32 degree downwardly.

The fourth step is a step of discharging a body part by hot air and two step wind force for 30 seconds. Then the air guide (7) is moved to about 18 degree downwardly.

The fifth step is a step of discharging a leg part by hot air and three step wind force for 20 seconds.

The sixth step is a swing mode operated upwardly and downwardly within a range of about 25-75 degree with respect to a perpendicular section.

The second exemplified automatic module 2 is a module set considering a short hair style of man and woman. A blast, cold wind is applied to the body in a relatively short time and the last wholly. In the latter half of the module, it can give comfortable and cold refreshment to the skin.

The first step is a step of discharging a head part by hot air and two step wind force for 1 min. Then, the air guide (7) is moved to about 32 degree upwardly.

The second step is a step of discharging a body part by hot air and three step wind force for 30 seconds.

The third step is a step of conducting a return-swing operation upwardly and downwardly within a range of about 25˜75 degree with respect to a perpendicular section and discharging an air guide (7) for 20 seconds.

The fourth step is a step of discharging a head part by hot air and two step wind force for 20 seconds. Then the air guide (7) is moved to about 32 degree downwardly.

The fifth step is a step of discharging a body part by hot air and two step wind force for 20 seconds.

The sixth step is a step of carrying out a wing mode operation upwardly and downwardly within a range of about 25˜75 degree with respect to a perpendicular section and discharging an air guide (7) by a clear air, not hot air, for about 30 seconds.

The third exemplified automatic module 3 is a module for man. The hot air and the blast time are identically set, and the head and body are dried for a short time and a whole body is dried by a clean air swing.

The first step is a step of discharging a head part by hot air and three step wind force for 30 seconds. Then, the air guide (7) is moved to about 32 degree upwardly.

The second step is a step of discharging a body part by hot air and three step wind force for 20 seconds.

The third step is a step of carrying out a wing mode operation upwardly and downwardly within a range of about 25˜75 degree with respect to a perpendicular section and discharging an air guide (7) by a hot air and three step wind force for about 20 seconds.

The fourth step is a step of carrying out a wing mode operation upwardly and downwardly within a range of about 25˜75 degree with respect to a perpendicular section and discharging an air guide (7) by a clean air, not hot air, and three step wind force for about 30 seconds.

Although the above module as well as any mode are set and used, the present invention is a structure revolved wholly by an air conditioner.

Therefore, when a hot air produced by an air blower (2) is discharged through a discharge opening (6), the discharge air pressure is not changed.

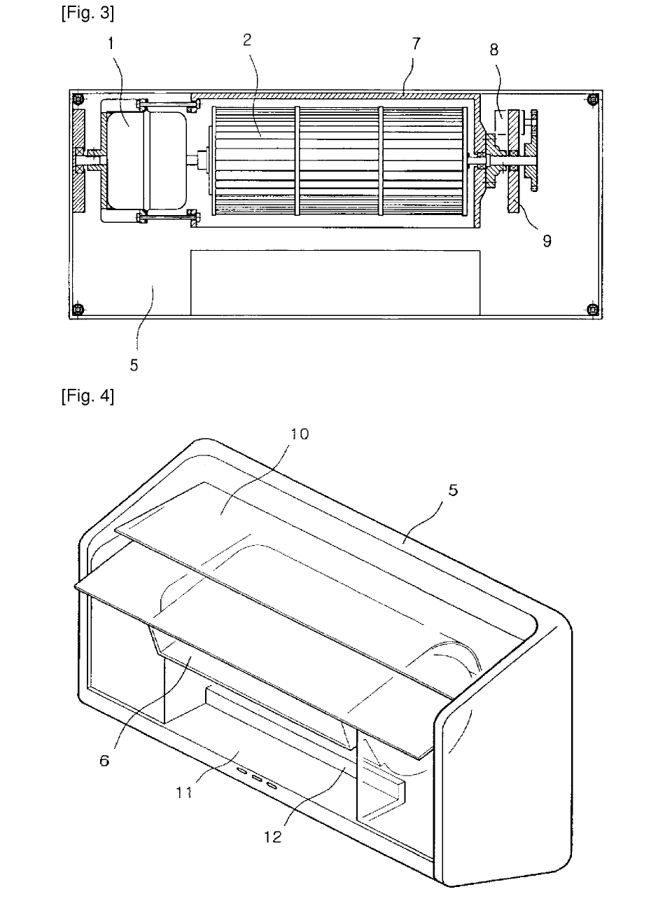

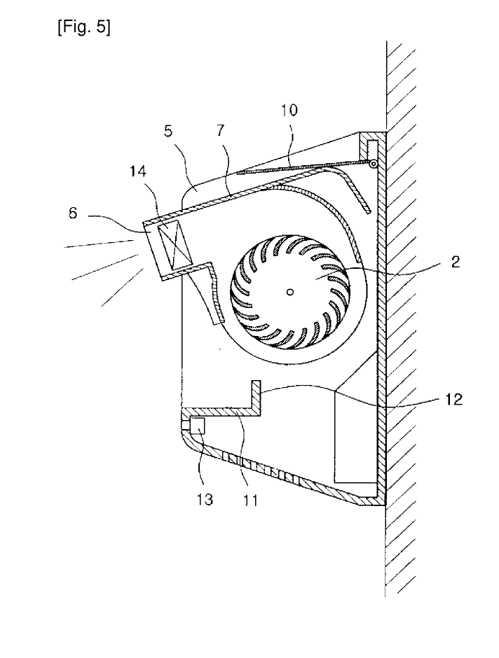

As shown in FIGS. 2 and 3, the operation of the air blower (2) is made by a blower motor (1).

The air blower (2) has a general cylindrical structure wherein the two ends are smoothly revolved.

The air guide is revolved on the center of the same axis as a revolving axis of the air blower (2). Therefore, when the air blower (2) is operated, the internal air is in-flowed and heated through an uptake hole (4) perforated in the lower part of the case (5), and an internal air is then in-flowed through the lower opening part of the air guide (7) and blown to a discharge opening (6).

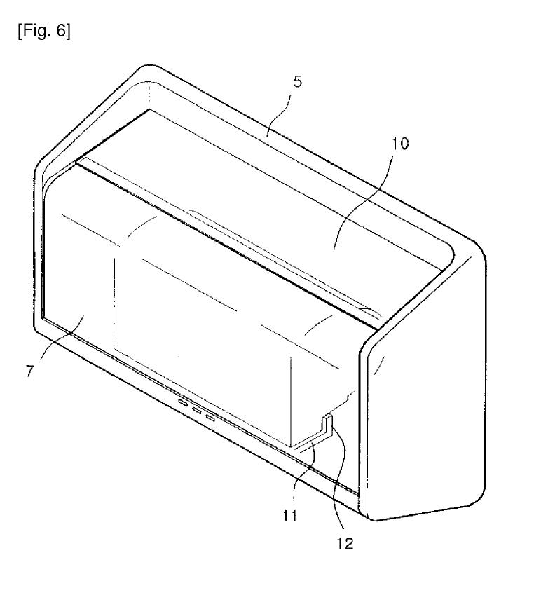

The operation state of air guide (7) is upwardly and downwardly revolved as shown in FIGS. 4 and 5. Here, an upper part of air guide (7) is covered by a cover (10).

Since the cover (10) is designed so that the end of the latter side is supported by a case (5) as shown in FIG. 5, the cover (10) is revolved although there is a part projected in the upper part during revolution of air guide (7).

Therefore, the upper opening part (3) of the case (5) can be covered.

In case where a hot air is discharged, the air is guided by the air guide (7) while revolving the surrounding of the air blower (2).

The present invention is designed so that air guide (7) is surrounded by an air blower (2). Therefore, although air guide (7) is revolved, movement of air due to the air blower (2) is not changed. Therefore, it has no effect on the noise and wind force.

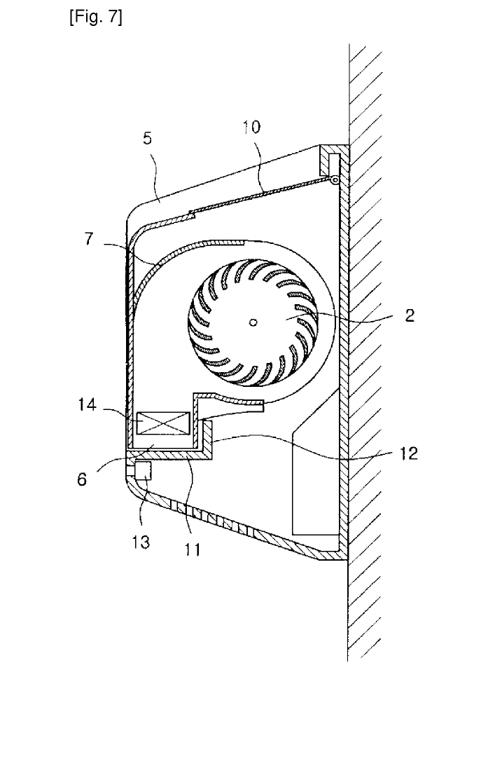

In case of not using it, the air guide (7) is in a folded state as shown in FIGS. 6 and 7.

In this case, it is in a state received in a fixed end (11) which is mounted in the lower end of the frontward opening part (3) of the case (5).

The opening part (3) of the air guide (7) is supported and fixed to a jaw projected in the internal end of the fixed end. Of course, as a general function, it can have a control part for input of a control signal for wireless control.

### INDUSTRIAL APPLICABILITY

According to this invention of well-being body drier and its controlling method is able to reduce a mechanical noise compared with a traditional machine, split pressure of wind, remove a bad smell of bathroom with a far infrared anion for deodorization and its function of emission, prevent a damage of skin by a far infrared anion of yellow loess.

Also, It crank up a sight (or appearance) of bathroom and the others by entering a discharge opening into the machine upon non-operation compared with a traditional machine.

1. A well-being body drier, comprising a case (5) which has an air blower motor (1) and an air blower (2) revolved by the blower motor (1), wherein an opening part (3) is formed in the upper part and the front part, and a plurality of intake openings (4) are formed in the lower part; an air guide which is mounted to surround the blower (2), a discharge opening (6) is formed to project at a front direction, and provided to revolve in an opening part (3) of the case (5) to a certain angle; and a heating element (14) mounted in the discharge opening (6).

2. The well-being body drier according to claim 1, wherein the above air guide (7) is driven by a servo-motor (8) installed within the case (5), and revolved on a center of the revolving axis of the blower (2).

3. The well-being body drier according to claim 1, wherein the opening part (3) formed in the upper part of the case (5) is mounted with a cover (10) by a structure which the backward end of the cover (10) is supported and revolved by the case (5), and the cover (10) places on the upper part of a revolving air guide (7) to cover the upper opening part (3).

4. The well-being body drier according to claim 1, wherein a fixed end (11) having a certain depth inside the case (5) is formed in the lower end of the front opening part (3) of the case (5), and an end jaw (12) is formed in the end part of the fixed end (11), so that the discharge opening (6) of the air guide (7) is safely fixed.

5. The well-being body drier according to claim 1, wherein the heating element (14) comprises a far infrared plate (15) mounted in the discharge opening (6), and a heating coil (16) spirally rolled to a far infrared plate (15).

6. The well-being body drier according to claim 5, wherein the far infrared plate (15) is prepared by a mica pad coated with tourmaline, or coated with a yellow earth to make a ceramic.

7. A method for controlling the body drier which dries a moisture of body by controlling the direction of the discharge opening (6) of the air guide (7) mounted in the body drier, which comprises a step of determining an angle of head part determined by a line formed of a discharge opening (6) and an end part of user's head positioned separately at certain distance, and a line formed of a discharge opening (6) and user's neck; an angle of body part determined by a line formed of a discharge opening (6) and neck, and a line formed of a discharge opening (6) and user's waist; an angle of tiptoe determined by a line formed of a discharge opening (6) and a waist, and a line formed of a discharge opening (6) and user's tiptoe; and an angle of body part determined by a line formed of a head end part and a discharge opening (6), and a line formed of a discharge opening (6) and tiptoe; and a step of determining the direction of the discharge opening (6) within a range of angle corresponding to the part for drying user's moisture and carrying out a return-operation within the range of the above determined angle.
